(19) United States
(12) Patent Application Publication
(10) Pub. No.: US 2009/0085761 A1
(43) Pub. Date: Apr. 2, 2009

(54) System and Method for Identifying Attempts to Tamper with a Terminal Using Geographic Position Data

(75) Inventor: Mark BUER, Gilbert, AZ (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 12/239,665

(22) Filed: Sep. 26, 2008

Related U.S. Application Data
(60) Provisional application No. 60/960,405, filed on Sep. 28, 2007.

(51) Int. Cl. G08B 21/00

(52) U.S. Cl. 340/686.1

(57) ABSTRACT

The present invention provides systems, methods, and computer program products for identifying possible attempts to tamper with a terminal using geographic position data. For a terminal, a geographic usage policy is defined that identifies an allowable geographic operational zone for the terminal. The geographic usage policy may also include corrective action or actions based on violations of the usage policy. The type of corrective action may vary based on the details associated with the violation (e.g., distance from the operational zone, time of day, etc.). A tamper identification module receives geographic position data from a global positioning system within the terminal. The tamper identification module then determines whether the received position data is within the allowable geographic operation zone for the terminal. If the position data is not within the allowable geographic operation zone, then the appropriate corrective action is performed.

### CROSS REFERENCE TO RELATED APPLICATIONS

This application claims the benefit of U.S. Provisional Application No. 60/960,405 filed Sep. 28, 2007, which is incorporated herein by reference in its entirety.

### FIELD OF THE INVENTION

This application relates generally to data communications and more specifically to information security.

### BACKGROUND OF THE INVENTION

Credit cards and debit cards have become essential forms of payment for consumers. Retail establishments have installed point of sale (POS) terminals designed to read a customer credit card and communicate with card issuers to determine whether the requested transaction is authorized. POS terminals range from fixed cash register type terminals to mobile portable card readers. POS terminals are designed with certain security precautions. For example, many POS terminals do not retain consumer credit card data after a transaction is completed. However, because of their ability to read a credit card and/or debit card, POS terminals are popular targets for hackers, fraud perpetrators, or other malicious individuals seeking to circumvent the existing security measures and gain access to customer financial data.

One popular credit card/debit card fraud technique is referred to as “skimming.” Skimming involves the theft of credit card or debit card information required to complete a financial transaction. Rudimentary forms of skimming involve physically copying data directly from the card (e.g., card holder name, card number, and expiration date). More advanced forms of skimming involve the modification of POS terminals to intercept and retain customer financial data. Such modification often involves physically moving the POS terminal from the retail location to another geographic location where the POS terminal is altered.

In addition to POS terminals, other types of equipment may be targets for theft or similar modification. For example, many financial institutions store consumer financial information on one or more servers or databases, including cryptographic keys assigned to consumers for accessing their financial assets over a data network. While these devices may be secured from network-based intrusions, if an insider or intruder gains physical access to one of these servers or databases, the sensitive information stored therein maybe susceptible to retrieval.

What is therefore needed are methods and systems to detect when a terminal is moved outside of an allowable geographic zone of operation.

What is further needed are methods and systems to disable a terminal if the terminal is moved outside of an allowable geographic zone of operation.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary operating environment for a system and method for identifying attempts to hack a terminal using terminal geographic position data, according to embodiments of the present invention.

FIGS. 2A and 2B depict exemplary tamper-evident POS terminals, according to embodiments of the present invention.

FIGS. 3A and 3B depict exemplary tamper-evident computers/databases storing sensitive consumer security data, according to embodiments of the present invention.

FIG. 4 depicts a flowchart of an exemplary method for identifying potential attempts to tamper with a terminal, according to embodiments of the present invention.

FIG. 5 depicts a flowchart of an exemplary method for logging geographic information associated with a transaction, according to embodiments of the present invention.

FIG. 6 depicts a block diagram of an exemplary general purpose computer system.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

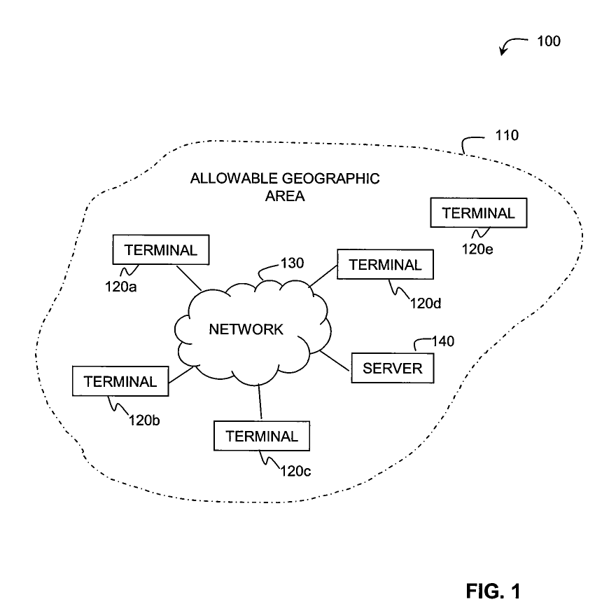

FIG. 1 illustrates an exemplary operating environment 100 for a system and method for identifying attempts to tamper with a terminal using geographic position data, according to embodiments of the present invention. Operating environment 100 includes one or more allowable geographic usage zones 110. An allowable geographic usage zone 110 defines the geographic boundaries within which one or more terminals 120 are allowed to operate. When a terminal is taken outside the boundaries defined by the allowable geographic zone 110, logic within the terminal assumes an attempt to tamper with the terminal may have occurred.

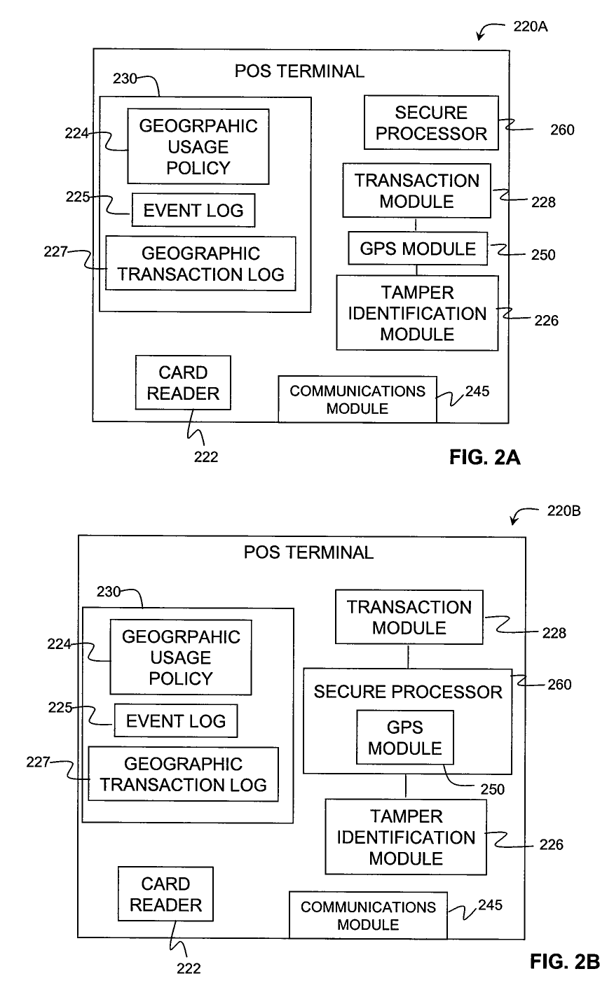

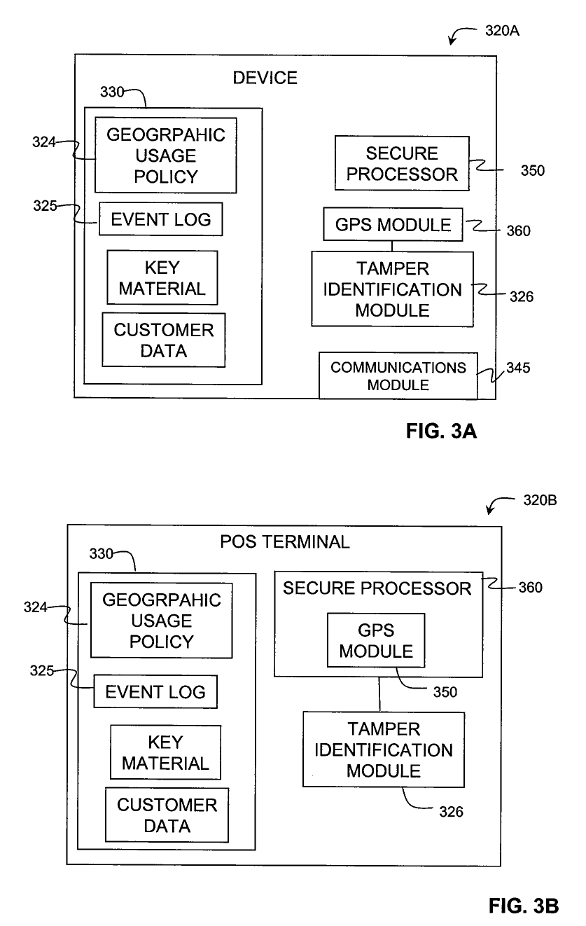

A terminal 120 may be a fixed or mobile point of sale (POS) terminal in a retail establishment. FIGS. 2A and 2B, described below, depict exemplary tamper evident POS terminals. In addition or alternatively, a terminal 120 may be a server, a database, or other computer system that stores sensitive consumer data such as, but not limited to, financial information, social security numbers, cryptographic keys and passwords. FIGS. 3A and 3B, described below, depict exemplary tamper evident security storage devices.

Terminals 120a-d may be coupled to network 130 when located within a geographic usage area 110. Terminals 120a-d may communicate with network 130 via a wired or wireless connection. A terminal, such as terminal 120e, may also operate as a stand-alone device. A geographic usage area 110 may also include one or more servers 140. Server 140 receives data from one or more terminals 120a-e or alternatively from a client (not shown) or application (not shown). Server 140 may include an event log configured to store potential tamper events generated by terminals 120. Server 140 may optionally include a transaction log. Transaction log is designed to store geographic transaction records generated by terminals 120. A geographic transaction record includes transaction information and associated geographic data.

FIGS. 2A and 2B depict exemplary tamper-evident POS terminals 220A and 220B, according to embodiments of the present invention. Tamper-evident POS terminals 220A and B include an optional card reader 222, a global positioning system (GPS) module 250, a secure processor 260, and storage 230. As would be appreciated by persons of skill in the art other techniques for satellite positioning or determining device position could be used with the present invention. POS terminals 220A and B also include a tamper identification logic module 226 and a memory storing geographic usage policy 224 and a suspicious event log 225. POS terminals 220A, B may also include a geographic transaction log 227

GPS module 250 is configured to determine the geographic position of terminal 220A, B. GPS module 250 may be separate from secure processor 260, as illustrated in FIG. 2A. Alternatively, GPS module 250 may be integrated into the same chip as secure processor 260. GPS module 250 is configured to provide geographic position data or data which can be used to compute position to tamper identification logic module 226.

Secure processor 260 provides the required cryptographic operations to encrypt, decrypt, and/or authenticate data that is sent or received by the secure processor. Additionally, secure processor 260 securely maintains information and releases the information only after the requesting party is authenticated.

Secure processor 260 may comprise a processor, memory, and dedicated cryptographic hardware. In addition, secure processor 260 may incorporate other security mechanisms. For example, secure processor 260 may be configured to only execute secure (e.g., authenticated) code. In an embodiment, secure processor 260 is designed to conform to a security specification relating to, for example, FIPS or TPM.

A security boundary associated with secure processor 260 may be established, for example, using hardware and/or cryptographic techniques. Hardware techniques for providing a security boundary may include, for example, placing components within a single integrated circuit. In addition, one or more integrated circuits may be protected by a physical structure using tamper evident and/or tamper resistant techniques such as epoxy encapsulation. Encryption techniques for establishing a security boundary may include, for example, encrypting sensitive information before it leaves secure processor 360. For this purpose, secure processor 260 may use one or more cryptographic processors and store the associated encryption/decryption keys in a secure memory internal to secure processor 260.

In an embodiment, GPS module 250 is within the security boundary established by secure processor 260. In addition or alternatively, geographic usage policies 224 defined for the terminal and/or the tamper identification logic may also be maintained within the security boundary or within secure processor 260.

Card reader 222 is configured to read credit and/or debit cards. In an embodiment, card reader 222 is a contact-based. In a contact-based reader, the terminal has one or more electrical connectors which make contact with electrical connectors on the card or the reader has circuitry configured to read an encoded magnetic stripe. In addition or alternatively, card reader 222 is contactless. For example, the terminal may communicate with a credit card or debit card using radio frequency identification (RFID) induction technology, low frequency RFID, or near field communication (NFC) such as high frequency RFID, in accordance with, for example, ISO 14443 and ISO 15693.

Storage 230 may store one or more geographic usage policies for the terminal, an event log 225, and/or a geographic transaction log 226. Geographic usage policy 224 defines a geographic usage zone (110) associated with a terminal. In an embodiment, the geographic usage zone (110) defines an area in which a terminal is expected to be and/or allowed to operate. For example, a terminal owner/user may define a geographic usage zone to be a building, a specific area within a building, or an indoor/outdoor area (e.g., gas station, restaurant with outdoor seating, etc). The terminal owner/user may define the allowable geographic usage zone based on time of day or day of week. For example, geographic usage zone 1 may apply during time periods when the retail store is open and geographic usage zone 2 may apply during time periods when the retail store is closed.

A geographic usage policy 224 also defines actions to take in the event a suspicious event is detected. One form of corrective action is to log the suspicious event. In this action, when the terminal detects a violation of the geographic usage policy (e.g., terminal outside allowable zone of operation), the terminal logs the event in the suspicious event log. Another form of corrective action is to delete a predefined set of information stored in the terminal. The geographic usage policy 224 may define a list of data which must be erased from the terminal if a violation of the geographic usage policy is detected. For example, one or more encryption keys may be cleared. In addition or alternatively, a form of corrective action may be to disable all or a portion of functionality of the terminal. For example, the geographic usage policy 224 may specify that if a policy violation is detected, the card reader should be disabled. In a further example, the geographic usage policy 224 may specify that the entire terminal be made inoperable if a policy violation is detected.

Actions may also be defined based on the distance that a terminal is from the allowable geographic usage zone. For example, if a terminal is within a first defined distance from the allowable geographic zone, then action #1 is applied (e.g., logging events). If the terminal is farther then a specified distance from the allowable geographic zone, then action #2 is applied (e.g., disable). Geographic usage policies 224 are definable by a terminal owner/user. In an embodiment, geographic usage policies 224 are stored within the security boundary of the terminal. Note that additional security measures to secure the defined usage policies from alteration may be used with the current invention.

Event log 225 stores suspicious events detected by tamper identification logic module 226. An event may include the geographic position detected as well as additional information such as time the position was detected. The event log 225 may store each suspicious event detected or a subset of events detected. For example, the event log 225 may only store events having distances that differ by more than a specific amount.

Geographic transaction log 227 stores records related to transactions initiated at the terminal. A geographic transaction log record includes geographic position data associated with the transaction. The record may also include time the transaction was initiated and certain non-sensitive information about the transaction.

Tamper identification logic module 226 is configured to detect violations of a geographic usage policy 224. Tamper identification logic module 226 receives from GPS module 250 geographic position data or data that can be used to determine position and compares it to the criteria specified by the geographic usage policy 224 for the terminal. In embodiments, if a position is not received from GPS module, tamper identification module 226 includes logic to use the received data to determine a position. Tamper identification logic module 226 is then further configured to take a corrective action, as defined by the geographic usage policy 224. Tamper identification logic module 226 may further be configured to request geographic data from GPS module 250 (e.g., when the terminal is turned on, etc.). Tamper identification logic module 226 may be included in secure processor 260 or may be separate from secure processor 260.

Transaction processing module 228 is configured to receive geographic position data (or data that can be used to determine position). Transaction processing module 228 includes logic to associate the geographic position data with a transaction being processed. Transaction processing module 228 may be configured to request geographic data when a transaction is initiated. Alternatively, GPS module 250 may periodically send GPS data to transaction processing module 228.

Terminals 220A,B are further configured to transmit logged events to an external device (e.g., server 140). Terminal 220A,B may transmit the logged events in response to a request or may transmit logged events at periodic intervals or on the occurrence of a specific event. A terminal owner/user may use the received data to determine whether to a manual inspection/investigation of the terminal is required to confirm whether the terminal has been modified.

Communications module 245 enables terminal 220A,B to interact with external entities, such as server 140 to transmit logged events or receive instructions. In embodiments, communications module 245 enables TCP/IP traffic, although the invention is not limited to this example. More generally, communications module 245 enables communication over any type of communications medium, such as wireless or wired and using any communications protocol.

FIGS. 3A and 3B depict exemplary tamper-evident devices storing sensitive consumer security data 320A and 320B, according to embodiments of the present invention. Examples of devices 320A, B are hardware security modules used by financial institutions. Devices 320A, B may also include computers, databases, terminals, etc. Tamper-evident devices 320A and B include a global positioning system (GPS) module 350 and a secure processor 360. Devices 320A and B also include a tamper identification logic module 326 and a memory storing geographic usage policy 324 and a suspicious event log 325. GPS module 350, secure processor 360, tamper identification logic module 326, geographic usage policy 324, and suspicious event log 325 were described above in reference to FIGS. 2A and 2B.

As illustrated in FIGS. 3A and 3B, tamper-evident devices 320A, B are configured to store cryptographic key material associated with consumers. For example, a financial institution or corporation may assign customers or employees cryptographic keys for use when accessing systems, applications, or services. A financial customer may use a cryptographic key when making on-line financial transactions. Additionally or alternatively, these devices may also store other sensitive consumer information such as passwords, social security numbers, etc.

Because of the nature of the information stored within these devices, these devices are targets for theft. Tamper identification logic module 326 can be used to identify when these devices are moved from their allowable usage zone (which may be a very limited space such as a single room) and immediately erase any sensitive information before it can be compromised.

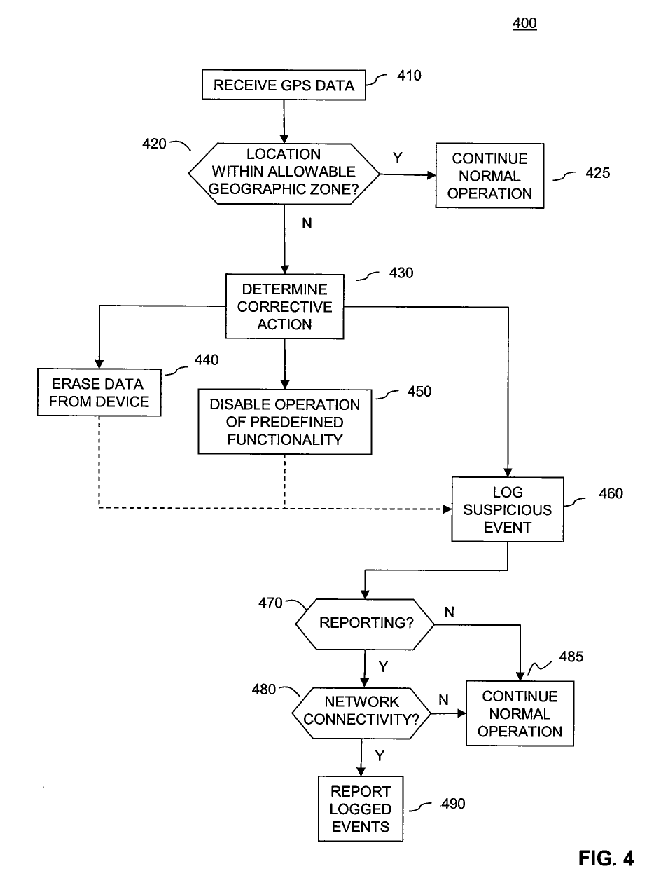

FIG. 4 depicts a flowchart 400 of an exemplary method for identifying potential attempts to tamper with a terminal, according to embodiments of the present invention. Flowchart 400 is described with reference to FIGS. 1, 2A-B, and 3A-B. However, flowchart 400 is not limited to those embodiments. Note that some steps of flowchart 400 do not necessarily have to occur in the order shown.

In step 410, terminal geographic position data or data from which position can be calculated is received by tamper identification logic module 226, 326. In an embodiment, the geographic position data is generated by GPS module 250, 350. Geographic position data may be generated periodically by GPS module 250, 350. In addition or alternatively, geographic position data may be generated by request. If the tamper identification logic module receives data from which position can be calculated, the tramper identification module would the perform position determination for the terminal.

In step 420, a determination is made whether the received geographic position data is within an allowable zone of operation defined by the applicable geographic usage policy for the terminal. If the geographic position data is within the allowable zone of operation, operation proceeds to step 425. If the geographic position data is not within the allowable zone of operation, operation proceeds to step 430.

In step 425, normal operation continues, if the terminal is within the boundary.

In step 430, the appropriate corrective action is determined. The corrective action to be applied is determined by the geographic usage policy. A geographic usage policy may identify a sequence of correction actions. For example, the geographic usage policy may indicate that a set of data is erased from the device (e.g., clear one or more encryption keys) upon detection of a tamper attempt and that the attempt is entered into the suspicious event log.

The corrective actions may be specified for different levels of tamper attempts. For example, a first level tamper attempt may cause a first set of corrective actions (e.g., only log events) and a higher level tamper attempt may cause a second set of corrective actions (e.g., erase data or clear keys and log event). The level of tamper attempt may be based on the distance from the allowable zone of operation, time of day of the violation, and/or other factors. Alternatively, a single corrective action may be applied for all detected tamper attempts. Flowchart 400 depicts three exemplary corrective action. If the corrective action is to erase data from the device, operation proceeds to step 440. If the corrective action is to disable all or a portion of terminal functionality, operation proceeds to step 450. If the corrective action is to log the event, operation proceeds to step 460. As would be appreciated by persons of skill in the art, other types of corrective action could be defined.

In step 440, secure processor 260, 360 erases information from the terminal. In an embodiment, the geographic usage policy 324 includes details on what information is to be deleted from the terminal if a possible tamper evident is detected. In an alternative embodiment, the entire contents of storage 230 are erased. Step 440 is optional Operation may proceed to step 450 or step 460 if the geographic usage policy indicates that additional corrective actions are required.

In step 450, secure processor 260, 360 disables operation of all or a portion of terminal functionality. Step 450 is optional. The performance of step 450 is dependent upon the parameters of the geographic usage policy. Operation may proceed to step 440 or step 460 if the geographic usage policy indicates that additional corrective actions are required.

In step 460, details related to the potentially suspicious event are stored in terminal 220, 320. For example, the terminal 220, 320 may store the geographic position data and time when the suspicious event was detected.

In step 470, a determination is made suspicious events are to be reported upon occurrence of an event. This step is optional. If events are to be reported, operation proceeds to step 480. If events are not to be reported, operation proceeds to step 485.

In step 480, a determination is made whether the terminal is connected to the network for the geographic usage zone. If the terminal is connected to the network, operation proceeds to step 490. If the terminal is not connected to the network, operation proceeds to step 485.

In step 485, the terminal continues normal operation until network connectivity is detected.

In step 490, the terminal transmits any logged suspicious events to an external computer or system (e.g., server 140).

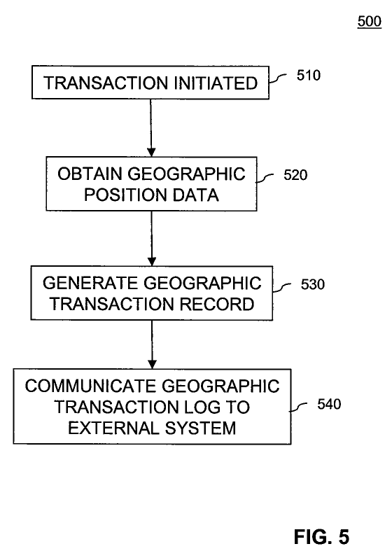

In addition to identifying possible attempts to tamper with or remove a terminal from its authorized operating area, position data can also be utilized to provide additional information about a transaction. FIG. 5 depicts a flowchart 500 of an exemplary method for logging geographic information associated with a transaction, according to embodiments of the present invention. Flowchart 500 is described with reference to FIGS. 1, 2A-B, and 3A-B. However, flowchart 500 is not limited to those embodiments. Note that some steps of flowchart 500 do not necessarily have to occur in the order shown.

In step 510, a transaction is initiated at the terminal. For example, entry of a credit or debit card payment (e.g., by card “swipe” or card “read”) is detected at the terminal. Alternatively, the system may detect the entry of an item to be purchased (e.g., bar code scan of an item at the checkout counter).

In step 520, geographic position data or data that can be used to determine position is obtained from GPS module. In an embodiment, the transaction module 228 is configured to process geographic position data for a transaction. The transaction module 228 may request geographic information when a transaction is detected. Alternatively, the GPS module may periodically send data to transaction module 228.

In step 530, a geographic transaction record is generated for example, by the transaction module, and stored in geographic transaction log 227 in storage 230.

In step 540, the geographic transaction log contents are communicated to an external system.

The geographic transaction log contents may then be used to provide a retailer with location based knowledge of where (and optionally when) transactions occurred.

The embodiments of the present invention, or portions thereof, can be implemented in hardware, firmware, software, and/or combinations thereof.

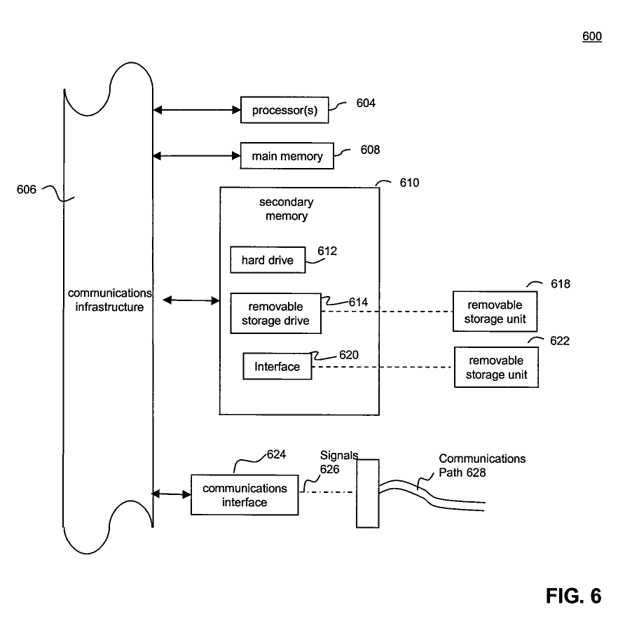

The following description of a general purpose computer system is provided for completeness. Embodiments of the present invention can be implemented in hardware, or as a combination of software and hardware. Consequently, embodiments of the present invention, may be implemented in the environment of a computer system or other processing system. An example of such a computer system 600 is shown in FIG. 6. The computer system 600 includes one or more processors, such as processor 604. Processor 604 can be a special purpose or a general purpose digital signal processor. The processor 604 is connected to a communication infrastructure 606 (for example, a bus or network). Various software implementations are described in terms of this exemplary computer system. After reading this description, it will become apparent to a person skilled in the relevant art how to implement the invention using other computer systems and/or computer architectures.

Computer system 600 also includes a main memory 608, preferably random access memory (RAM), and may also include a secondary memory 610. The secondary memory 610 may include, for example, a hard disk drive 612, and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618, represents a floppy disk, magnetic tape, optical disk, etc. As will be appreciated, the removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a PCMCIA slot and card, etc. Software and data transferred via communications interface 624 are in the form of signals 628 which may be electronic, electromagnetic, optical or other signals capable of being received by communications interface 624. These signals 628 are provided to communications interface 624 via a communications path 626. Communications path 626 carries signals 628 and may be implemented using wire or cable, fiber optics, a phone line, a cellular phone link, an RF link and other communications channels.

The terms “computer program medium” and “computer usable medium” are used herein to generally refer to media such as removable storage drive 614, a hard disk installed in hard disk drive 612, and signals 628. These computer program products are means for providing software to computer system 600.

Computer programs (also called computer control logic) are stored in main memory 608 and/or secondary memory 610. Computer programs may also be received via communications interface 624. Such computer programs, when executed, enable the computer system 600 to implement the present invention as discussed herein. In particular, the computer programs, when executed, enable the processor 604 to implement the processes of the present invention. Where the invention is implemented using software, the software may be stored in a computer program product and loaded into computer system 600 using raid array 616, removable storage drive 614, hard drive 612 or communications interface 624.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A device for identifying attempts to tamper with a device using geographic position data for the device, comprising:
a geographic positioning system (GPS) module;
a memory configured to store a geographic usage policy for the device, wherein the geographic usage policy defines an allowable geographic operation zone for the device; and
a secure processor including a tamper identification logic module, the tamper identification logic module configured to:
receive geographic position data from the GPS module indicative of a geographic location of the device,
determine whether the geographic location of the device is within the allowable geographic operation zone for the device, and
perform a corrective action identified in the geographic usage policy if the location of the device is not within the allowable geographic zone.

2. The device of claim 1, wherein the GPS module and at least a portion of the memory is within a security boundary established by the secure processor.

3. The device of claim 1, wherein the device is a point of sale (POS) terminal.

4. The device of claim 1, wherein the device is a hardware security module.

5. The device of claim 1, wherein the GPS module and the secure processor are on the same chip.

6. The device of claim 1, wherein the geographic usage policy defines the corrective action to perform based on the geographic position of the device.

7. The device of claim 6, wherein the corrective action is generation of an suspicious event record.

8. The device of claim 6, wherein the corrective action is the deletion of data identified for deletion in the geographic usage policy.

9. The device of claim 6, wherein the corrective action is the disablement of functionality of the device.

10. The device of claim 6, wherein the corrective action is clearing an encryption key.

11. A method for identifying attempts to tamper with a device using geographic position data for the device, comprising:
receiving geographic position data from a global positioning system (GPS) module;
determining, in a secure processor within the device, whether the received geographic position data is within an allowable geographic usage zone defined by a geographic usage policy defined for the device; and
if the received geographic position data is not within the allowable geographic usage zone, performing a corrective action, wherein the corrective action is defined by the geographic usage policy.

12. The method of claim 11, wherein performing a corrective action comprises:
generating a suspicious event record, wherein the suspicious event record includes the received geographic position.

13. The method of claim 11, wherein performing a corrective action comprises:
deleting a set of data defined by the geographic usage policy.

14. The method of claim 11, wherein performing a corrective action comprises:
disabling functionality of the device.

15. The method of claim 11, further comprising:
identifying a transaction initiation;
obtaining geographic position data for the device; and
generating a geographic transaction record for the transaction, wherein the geographic transaction includes the geographic position of the device, a transaction time, and associated transaction information.

16. The method of claim 12, further comprising:
transmitting the suspicious event record to an external system.

17. The method of claim 15, further comprising:
transmitting the geographic transaction record to an external system.

18. The method of claim 11, wherein the device is a point of sale (POS) terminal.

19. The method of claim 11, wherein the device is a hardware security module.

20. A computer program product comprising a computer useable storage medium including control logic stored therein enabling the identification of attempts to tamper with a device using geographic position data for the device, comprising:
means for enabling a processor to receive geographic position data from a global positioning system (GPS) module;
means for enabling the processor to determine whether the received geographic position data is within an allowable geographic usage zone defined by a geographic usage policy defined for the device; and
means for enabling the processor to perform a corrective action, wherein the corrective action is defined by the geographic usage policy if the received geographic position data is not within the allowable geographic usage zone.
